(19) United States
(12) Patent Application Publication
(10) Pub. No.: US 2022/0119582 A1
(43) Pub. Date: Apr. 21, 2022

(54) METHACRYLATE MONOMER-BASED COMPOSITION

(71) Applicant: BOSTIK SA, Colombes (FR)

(72) Inventors: Guillaume MICHAUD, Venette (FR); Aurelie BOUTEILLE, Venette (FR)

(21) Appl. No.: 17/442,698

(22) PCT Filed: Mar. 25, 2020
(86) PCT No.: PCT/EP2020/058296

§ 371 Date: Sep. 24, 2021

(30) Foreign Application Priority Data
Mar. 28, 2019 (FR) FR1903224

(51) Int. Cl. C08G 18/67; C09J 175/04; C08G 18/76

(52) U.S. Cl. CPC C08G 18/672; C08G 18/7657; C09J 175/04

(57) ABSTRACT

The application relates to a two-component composition comprising:
a component A comprising:
   at least one polyurethane P having at least two terminal (meth)acrylate functions;
   at least one reducing agent; and
   at least one (meth)acrylate monomer M1 selected from among the following compounds and mixtures thereof:

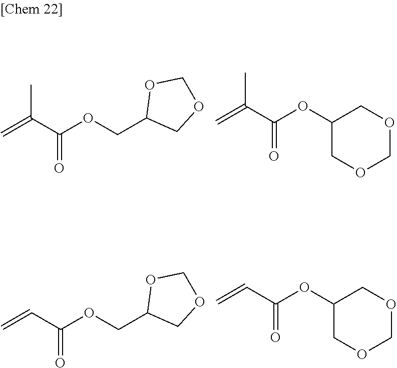

a component B comprising:
   at least one oxidizing agent; and
   optionally at least one methacrylate monomer.

### FIELD OF THE INVENTION

The present invention relates to a composition based on a methacrylate monomer.

The invention also relates to the use of said composition in the repair and/or the semistructural or structural adhesive bonding of materials in the transportation, marine, assembly or construction field.

### TECHNOLOGICAL BACKGROUND

Acrylic compositions are known reactive systems which crosslink by radical polymerization. They are used as adhesives, mastics and coatings. Radical polymerization is typically initiated by a redox system which, by means of an oxidation-reduction reaction, results in the production of radicals.

Most acrylic systems are two-component systems. The first component conventionally contains the reducing agent and the reactive monomers, and the second component contains the oxidizing agent. Once the two components have been mixed, the reducing agent induces cleavage of the O—O bond of the organic peroxide for example, and initiates polymerization.

Acrylates and methacrylates, in particular those with alkyl radicals, are monomers which have a high vapor pressure. As a consequence, they are odorous when they are applied.

Alternatives to these components have been developed. However, these alternative compositions do not make it possible to obtain good adhesive and/or mechanical properties.

There is therefore a need for new acrylic compositions which have little odor while at the same time having good adhesion properties.

There is a need for new acrylic compositions which have little odor while at the same time having good mechanical properties.

### DESCRIPTION OF THE INVENTION

In the present application, unless otherwise indicated:
the amounts expressed in the percentage form correspond to weight/weight percentages;
the hydroxyl number of an alcoholic compound represents the number of hydroxyl functions per gram of product, which is expressed in the form of the equivalent number of milligrams of potassium hydroxide (mg KOH/g) used in the quantitative determination of the hydroxyl functions, per gram of product;
the viscosity measurement at 23° C. (or at 100° C.) may be performed using a Brookfield viscometer according to the standard ISO 2555. Typically, the measurement taken at 23° C. (or at 100° C.) may be performed using a Brookfield RVT viscometer with a spindle suitable for the viscosity range and at a rotational speed of 20 revolutions per minute (rpm);
the number-average molecular weights (Mn) of the polyols, expressed in g/mol, are calculated from their hydroxyl numbers (OHN) and from their functionalities.

Composition

The present invention also relates to a two-component composition comprising:
a component A comprising:
   at least one polyurethane P comprising at least two (meth)acrylate end functions;
   at least one reducing agent; and
   at least one (meth)acrylate monomer M1 chosen from among the following compounds and mixtures thereof:

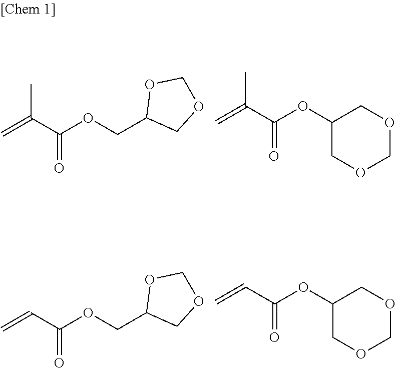

a component B comprising:
   at least one oxidizing agent; and
   optionally at least one (meth)acrylate monomer.

Component A

Polyurethane P

The polyurethane P may have a number-average molecular weight (Mn) greater than or equal to 2000 g/mol, preferably greater than or equal to 5000 g/mol, preferentially greater than or equal to 7000 g/mol, even better still greater than or equal to 10 000 g/mol. The Mn of the polyurethane is measured by GPC with comparison with a PS reference.

The polyurethane P may be obtained by a method comprising:
E1) a step of preparing a polyurethane comprising at least two NCO end groups comprising the polyaddition reaction between:
i) at least one polyisocyanate; and
ii) at least one polyol;
E2) reacting the product formed on conclusion of step E1) with at least one (meth)acrylate monomer M2 comprising at least one hydroxyl function.

Polyisocyanate(s)

The polyisocyanate(s) which can be used can be added sequentially or reacted in the form of a mixture.

The polyisocyanate(s) can be chosen from diisocyanates or triisocyanates.

The polyisocyanate(s) can be monomer(s), oligomer(s) or polymer(s).

According to one embodiment, the polyisocyanate(s) are diisocyanate(s), preferably chosen from the group consisting of isophorone diisocyanate (IPDI), hexamethylene diisocyanate (HDI), heptane diisocyanate, octane diisocyanate, nonane diisocyanate, decane diisocyanate, undecane diisocyanate, dodecane diisocyanate, 2,4′-methylenebis(cyclohexyl isocyanate) (2,4′-H6MDI), 4,4′-methylenebis(cyclohexyl isocyanate) (4,4′-H6MDI), norbornane diisocyanate, norbornene diisocyanate, 1,4-cyclohexane diisocyanate (CHDI), methylcyclohexane diisocyanate, ethylcyclohexane diisocyanate, propylcyclohexane diisocyanate, methyldiethylcyclohexane diisocyanate, cyclohexanedimethylene diisocyanate, 1,5-diisocyanato-2-methylpentane (MPDI), 1,6-diisocyanato-2,4,4-trimethylhexane, 1,6-diisocyanato-2,2,4-trimethylhexane (TMDI), 4-isocyanatomethyl-1,8-octane diisocyanate (TIN), 2,5-bis(isocyanatomethyl)bicyclo[2.2.1]heptane (2,5-NBDI), 2,6-bis(isocyanatomethyl)bicyclo[2.2.1]heptane (2,6-NBDI), bis(isocyanatomethyl)cyclohexane (H6-XDI) (in particular 1,3-bis(isocyanatomethyl)cyclohexane (1,3-H6-XDI)), xylylene diisocyanate (XDI) (in particular m-xylylene diisocyanate (m-XDI)), toluene diisocyanate (in particular toluene-2,4-diisocyanate (2,4-TDI) and/or toluene-2,6-diisocyanate (2,6-TDI)), diphenylmethane diisocyanate (in particular diphenylmethane-4,4′-diisocyanate (4,4′-MDI) and/or diphenylmethane-2,4′-diisocyanate (2,4′-MDI)), tetramethylxylylene diisocyanate (TMXDI) (in particular tetramethyl-m-xylylene diisocyanate), an HDI allophanate having, for example, the following formula (Y):

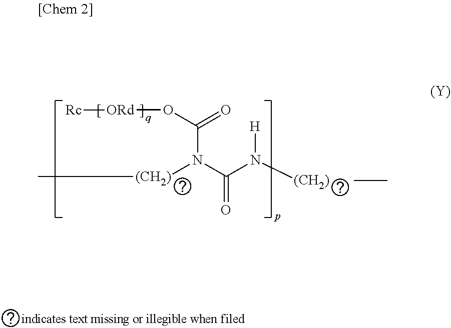

wherein p is an integer ranging from 1 to 2, q is an integer ranging from 0 to 9 and preferably from 2 to 5, R_{c} represents a saturated or unsaturated, cyclic or acyclic, linear or branched, hydrocarbon-based chain comprising from 1 to 20 carbon atoms, preferably from 6 to 14 carbon atoms, and R_{d} represents a linear or branched divalent alkylene group having from 2 to 4 carbon atoms, and preferably a divalent propylene group;

and mixtures thereof.

Preferably, the allophanate of abovementioned formula (Y) is such that p, q, R_{c} and R_{d} are chosen such that the above HDI allophanate derivative comprises a content of isocyanate NCO groups ranging from 12% to 14% by weight, relative to the weight of said derivative.

According to one embodiment, the polyisocyanate(s) which can be used are triisocyanate(s), preferably chosen from isocyanurates, biurets, and adducts of diisocyanates and of triols.

In particular, the isocyanurate(s) can be used in the form of a technical mixture of (poly)isocyanurate(s) with a purity of greater than or equal to 70% by weight of isocyanurate(s).

The diisocyanate isocyanurate(s) which can be used according to the invention can correspond to the following general formula (W):

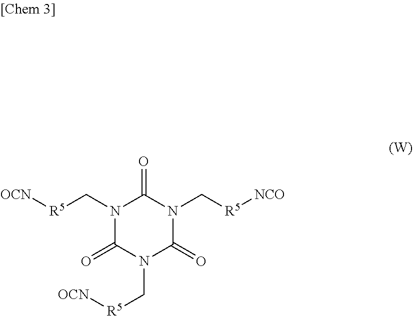

wherein:

R⁵ represents a linear or branched, cyclic, aliphatic, arylaliphatic or aromatic alkylene group comprising from 4 to 9 carbon atoms,

with the proviso that the NCO groups are not connected by a covalent bond to a carbon atom forming part of an aromatic hydrocarbon-based ring, such as a phenyl group.

As examples of diisocyanate trimers that may be used according to the invention, mention may be made of:
the isocyanurate trimer of hexamethylene diisocyanate (HDI):

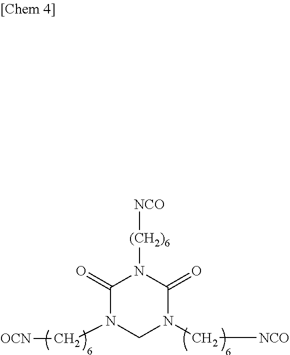

the isocyanurate trimer of isophorone diisocyanate (IPDI):

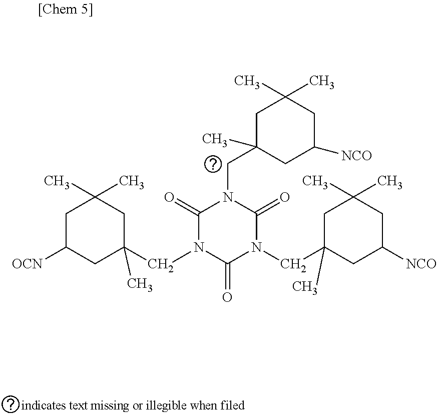

the isocyanurate trimer of pentamethylene diisocyanate (PDI):

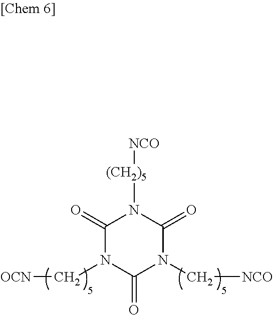

the isocyanurate trimer of meta-xylylene diisocyanate (m-XDI):

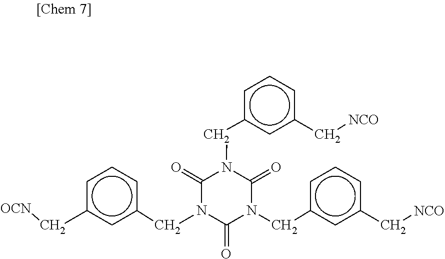

the isocyanurate trimer of m-XDI, in the hydrogenated form:

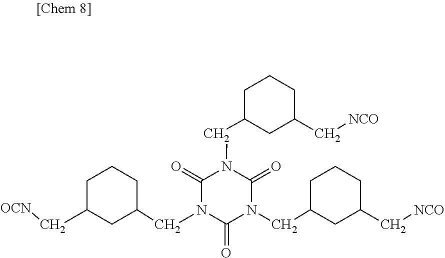

Mention may be made, as examples of adducts of diisocyanates and of triols which can be used according to the invention, of the adduct of meta-xylylene diisocyanate and of trimethylolpropane, as represented below. This adduct is sold, for example, by Mitsui Chemicals, Inc. under the name Takenate® D-110N.

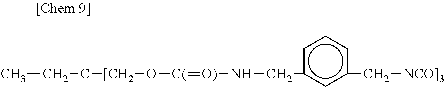

Preferably, the polyisocyanate(s) is (are) chosen from diisocyanates, preferentially from toluene diisocyanate (in particular the 2,4-TDI isomer, the 2,6-TDI isomer or mixtures thereof), diphenylmethane-4,4′-diisocyanate, diphenylmethane-2,4′-diisocyanate, meta-xylylene diisocyanate (m-XDI), isophorone diisocyanate (IPDI), and mixtures thereof.

Even more preferably, the polyisocyanate is chosen from polyisocyanates based on diphenylmethane diisocyanate (MDI), and in particular from monomeric and polymeric polyisocyanates.

The diphenylmethane diisocyanate can be provided in the form of a single isomer, for example chosen from 2,4′-MDI and 4,4′-MDI, or in the form of a mixture of isomers, for example 2,4′-MDI and 4,4′-MDI.

Usable polyisocyanate(s) is (are) typically commercially available. Mention may be made, by way of example, of Scuranate® TX sold by Vencorex, corresponding to a 2,4-TDI with a purity of the order of 95%, Scuranate® T100 sold by Vencorex, corresponding to a 2,4-TDI with a purity of greater than 99% by weight, Desmodur® I sold by Covestro, corresponding to an IPDI, or also Desmodur® N3300 sold by Covestro, corresponding to an HDI isocyanurate, Takenate™ 500 sold by Mitsui Chemicais, corresponding to an m-XDI, Takenate™ 600 sold by Mitsui Chemicals, corresponding to an m-H6XDI, Vestanat® H12MDI sold by Evonik, corresponding to an H12MDI, or of Suprasec 2004 sold by Huntsman (mixture of approximately 70% by weight of 4,4′-MDI monomer and of 30% by weight of 2,4′-MDI monomer, having a percentage of NCO of 32.8%).

Preferably, the polyisocyanate is chosen from:
monomeric diphenylmethane diisocyanate such as, for example, a mixture of approximately 70% by weight of 4,4′-MDI monomer and of 30% by weight of 2,4′-MDI monomer, or 4,4′-MDI; or else 4,4′-MDI alone;
polymeric diphenylmethane diisocyanate having in particular an NCO percentage of 32.8%.

Polyol(s)

The polyol(s) can be chosen from polyester polyols, polyether polyols, polyene polyols, polycarbonate polyols, poly(ether-carbonate) polyols and mixtures thereof.

The polyol(s) that can be used can be chosen from aromatic polyols, aliphatic polyols, arylaliphatic polyols and the mixtures of these compounds.

The polyol(s) which can be used can be chosen from that (those) having a number-average molecular weight (Mn) ranging from 200 g/mol to 20 000 g/mol, preferably from 400 g/mol to 18 000 g/mol.

The number-average molecular weight of the polyols can be calculated from the hydroxyl number (OHN), expressed in mg KOH/g, and from the functionality of the polyol or determined by methods well known to those skilled in the art, for example by size exclusion chromatography (or SEC) with PEG (polyethylene glycol) standard.

Preferably, the polyols have a hydroxyl functionality ranging from 2 to 6. In the context of the invention, and unless otherwise mentioned, the hydroxyl functionality of a polyol is the mean number of hydroxyl functions per mole of polyol.

According to the invention, the polyester polyol(s) can have a number-average molecular weight ranging from 1000 g/mol to 10 000 g/mol, preferably from 2000 g/mol to 6000 g/mol.

Among the polyester polyols, examples that may be mentioned include:
polyester polyols of natural origin, such as castor oil;
polyester polyols resulting from the polycondensation:
   of one or more aliphatic (linear, branched or cyclic) or aromatic polyols, such as, for example, monoethylene glycol, diethylene glycol, 1,2-propanediol, 1,3-propanediol, 1,4-butanediol, butenediol, 1,6-hexanediol, cyclohexanedimethanol, tricyclodecanedimethanol, neopentyl glycol, cyclohexanedimethanol, a polyether polyol, glycerol, trimethylolpropane, 1,2,6-hexanetriol, sucrose, glucose, sorbitol, pentaerythritol, mannitol, N-methyidiethanolamine, triethanolamine, a fatty alcohol dimer, a fatty alcohol trimer and mixtures thereof, with
   one or more polycarboxylic acids or its ester or anhydride derivative, such as 1,6-hexanedioic acid (adipic acid), dodecanedioic acid, azelaic acid, sebacic acid, adipic acid, 1,18-octadecanedioic acid, phthalic acid, isophthalic acid, terephthalic acid, succinic acid, a fatty acid dimer, a fatty acid trimer and the mixtures of these acids, an unsaturated anhydride, such as, for example, maleic or phthalic anhydride, or alactone, such as, for example, caprolactone;
estolide polyols resulting from the polycondensation of one or more hydroxy acids, such as ricinoleic acid, with a diol (mention may be made, for example, of Polycin® D-1000 and Polycin® D-2000 available from Vertellus).

The abovementioned polyester polyols can be prepared conventionally and are for the most part commercially available.

Mention may be made, among polyester polyols, for example, of the following products with a hydroxyl functionality equal to 2:
Tone® 0240 (sold by Union Carbide), which is a polycaprolactone with a number-average molecular weight of approximately 2000 g/mol and a melting point of approximately 50° C.,
Dynacoll® 7381 (sold by Evonik) with a number-average molecular weight of approximately 3500 g/mol and having a melting point of approximately 65° C.,
Dynacoll 7360 (sold by Evonik), which results from the condensation of adipic acid with hexanediol and has a number-average molecular weight of approximately 3500 g/mol and a melting point of approximately 55° C.,
Dynacoll® 7330 (sold by Evonik) with a number-average molecular weight of approximately 3500 g/mol and having a melting point of approximately 85° C.,
Dynacoll 7363 (sold by Evonik), which also results from the condensation of adipic acid with hexanediol and has a number-average molecular weight of approximately 5500 g/mol and a melting point of approximately 57° C.,
Dynacoll® 7250 (sold by Evonik): polyester polyol having a viscosity of 180 Pa·s at 23° C., a number-average molecular weight Mn equal to 5500 g/mol and a T_{g} equal to −50° C.,
Kuraray® P-6010 (sold by Kuraray): polyester polyol having a viscosity of 68 Pa·s at 23° C., a number-average molecular weight Mn equal to 6000 g/mol and a T_{g} equal to −64° C.,
Kuraray® P-10010 (sold by Kuraray): polyester polyol having a viscosity of 687 Pa·s at 23° C. and a number-average molecular weight Mn equal to 10 000 g/mol,
Realkyd® XTR 10410 (sold by Cray Valley): polyester polyol having a number-average molecular weight Mn in the vicinity of 1000 g/mol and the hydroxyl number of which ranges from 108 to 116 mg KOH/g. It is a product resulting from the condensation of adipic acid, diethylene glycol and monoethylene glycol,
Dekatol® 3008 (sold by Bostik) with a number-average molar mass Mn in the region of 1060 g/mol and the hydroxyl number of which ranges from 102 to 112 mg KOH/g. It is a product resulting from the condensation of adipic acid, diethylene glycol and monoethylene glycol;
Priplast® 3186 (sold by Croda): biobased polyester polyol having an OHN equal to 66 mg KOH/g;
Capa 2210 (sold by Perstorp): polycaprolactone polyol having an OHN equal to 60 mg KOH/g.

According to the invention, the polyether polyol(s) may have a number-average molecular weight ranging from 200 to 20 000 g/mol, preferably from 300 to 12 000 g/mol and preferentially from 400 to 4000 g/mol.

The polyether polyol(s) that may be used according to the invention is (are) preferably chosen from polyoxyalkylene polyols, the linear or branched alkylene portion of which comprises from 1 to 4 carbon atoms, more preferentially from 2 to 3 carbon atoms.

More preferentially, the polyether polyol(s) that may be used according to the invention is (are) preferably chosen from polyoxyalkylene diols or polyoxyalkylene triols, the linear or branched alkylene portion of which comprises from 1 to 4 carbon atoms, more preferentially from 2 to 3 carbon atoms.

As examples of polyoxyalkylene diols or triols that may be used according to the invention, mention may be made of:
polyoxypropylene diols or triols (also denoted by polypropylene glycol (PPG) diols or triols) having a number-average molecular weight (Mn) ranging from 300 to 12 000 g/mol;
polyoxyethylene diols or triols (also denoted by polyethylene glycol (PEG) diols or triols) having a number-average molecular weight (Mn) ranging from 300 to 12 000 g/mol;
and mixtures thereof.

The abovementioned polyether polyols may be prepared conventionally and are widely available commercially. They can be obtained by polymerization of the corresponding alkylene oxide in the presence of a basic catalyst (for example potassium hydroxide) or of a catalyst based on a double metal/cyanide complex.

Mention may be made, as examples of polyether diol, of:
Voranol® P1010 sold by Dow with a number-average molecular weight (Mn) in the vicinity of 1020 g/mol and the hydroxyl number of which is approximately 110 mg KOH/g;
Voranol® P2000 sold by Dow, a difunctional PPG with a number-average molecular weight of approximately 2000 g/mol;
Voranol® EP 1900: sold by DOW, difunctional PPG with a number-average molecular weight of approximately 4008 g/mol and with a hydroxyl number N_{OH} equal to 28 mg KOH/g;
Acclaim® 4200: difunctional PPG with a number-average molecular weight of approximately 4000 g/mol and with a hydroxyl number N_{OH} equal to 28 mg KOH/g;
Acclaim® 8200: difunctional PPG with a number-average molecular weight of 8016 g/mol, and a hydroxyl number OHN equal to 14 mg KOH/g;
Acclaim® 12200: difunctional PPG with a number-average molecular weight of 11,222 g/mol, and a hydroxyl number OHN equal to 10 mg KOH/g;
Acclaim® 18200: difunctional PPG with a number-average molecular weight of 17 265 g/mol, and a hydroxyl number OHN equal to 6.5 mg KOH/g.

Mention may be made, as examples of polyether triol, of the polyoxypropylene triol sold under the name Voranol® CP 450 by Dow with a number-average molecular weight (Mn) in the vicinity of 450 g/mol and the hydroxyl number of which ranges from 370 to 396 mg KOH/g, or the polyoxypropylene triol sold under the name Voranol® CP3355 by Dow with a number-average molecular weight in the vicinity of 3554 g/mol, or Acclaim® 6300, which is a trifunctional PPG with a number-average molecular weight of approximately 5948 g/mol and with a hydroxyl number N_{OH} equal to 28.3 mg KOH/g.

The polyene polyol(s) which can be used according to the invention can preferably be chosen from polyenes comprising hydroxyl end groups, and their corresponding hydrogenated or epoxidized derivatives.

Preferably, the polyene polyol(s) which can be used according to the invention is (are) chosen from polybutadienes including hydroxyl end groups, which are optionally hydrogenated or epoxidized. Preferentially, the polyene polyol(s) which can be used according to the invention is (are) chosen from butadiene homopolymers and copolymers comprising hydroxyl end groups, which are optionally hydrogenated or epoxidized.

In the context of the invention, and unless otherwise mentioned, the term “hydroxyl end groups” of a polyene polyol is understood to mean the hydroxyl groups located at the ends of the main chain of the polyene polyol.

The abovementioned hydrogenated derivatives can be obtained by complete or partial hydrogenation of the double bonds of a polydiene comprising hydroxyl end groups, and are thus saturated or unsaturated.

The abovementioned epoxidized derivatives can be obtained by chemoselective epoxidation of the double bonds of the main chain of a polyene comprising hydroxyl end groups, and thus comprise at least one epoxy group in their main chain.

Mention may be made, as examples of polyene polyols, of saturated or unsaturated butadiene homopolymers comprising hydroxyl end groups, which are optionally epoxidized, such as, for example, those sold under the name Poly BD® or Krasol® by Cray Valley, and also saturated or unsaturated isoprene homopolymers, comprising hydroxyl end groups, such as for example those sold under the name Poly IP™ or EPOL™ sold by Idemitsu Kosan.

The polycarbonate polyols may be chosen from polycarbonate diols or triols, in particular with a number-average molecular weight (Mₙ) ranging from 300 to 12 000 g/mol.

Examples of polycarbonate diols that may be mentioned include:
Converge® Polyol 212-10 and Converge® Polyol 212-20 sold by Novomer, with respective number-average molecular weights (Mn) equal to 1000 and 2000 g/mol, the hydroxyl numbers of which are, respectively, 112 and 56 mg KOH/g,
Desmophen® C XP 2716 sold by Covestro, with a number-average molecular weight (Mn) equal to 326 g/mol, and the hydroxyl number of which is 344 mg KOH/g,
Polyol C-590, C1090, C-2090 and C-3090 sold by Kuraray, with a number-average molecular weight (Mn) ranging from 500 to 3000 g/mol and a hydroxyl number ranging from 224 to 37 mg KOH/g.

Monomer(s) M2

The (meth)acrylate monomer M2 can be chosen from those having the following formula (I):

[Chem 10]

CH₂═C(R⁶)—C(═O)—O—R⁷—OH (I)

wherein:
R⁶ represents a methyl or a hydrogen, R⁶ preferably being a methyl;
R⁷ represents a saturated or unsaturated, aliphatic or cyclic, linear or branched, divalent hydrocarbon radical preferably comprising from 2 to 240 carbon atoms, and being optionally interrupted by one or more heteroatoms (such as, for example, N, O or S, and in particular O), and/or optionally interrupted by one or more aromatic groups, and/or optionally comprising one or more divalent —N(Rₐ)— groups with Rₐ representing a linear or branched alkyl radical comprising from 1 to 22 carbon atoms (tertiary amine), —C(═O)O— (ester), —C(═O)NH— (amide), —NHC(═O)O— (carbamate), —NHC(═O)—NH— (urea) or —C(═O)— (carbonyl) groups, and/or being optionally substituted.

Preferably, the monomer M2 has one of the following formulae:
Formula (I-1):

[Chem 11]

CH₂═C(R⁶)—C(═O)—O—R⁷—OH (I-1)

wherein:
R⁶ is as defined above;
R⁷ represents a saturated or unsaturated, linear or branched, aliphatic or cyclic, divalent alkylene radical comprising from 2 to 22 carbon atoms, preferably from 2 to 18, preferentially from 2 to 14, more preferentially still from 2 to 10 and advantageously from 2 to 6 carbon atoms;
Formula (I-2):

[Chem 12]

CH₂═C(R⁶)—C(═O)—O—R⁸—O—[C(═O)—(CH₂)_{w}—Oₛ—H (I-2)

wherein:
R⁶ is as defined above;
w is an integer ranging from 1 to 10, preferably from 1 to 5, and preferentially w is equal to 5;
s is an integer ranging from 1 to 10, s preferably being equal to 2;
R⁸ represents a saturated or unsaturated, linear or branched, aliphatic or cyclic, divalent alkylene radical comprising from 2 to 22 carbon atoms, preferably from 2 to 18, preferentially from 2 to 14, more preferentially still from 2 to 10 and advantageously from 2 to 6 carbon atoms;
Formula (I-3):

[Chem 13]

CH₂═C(R⁵)—C(═O)—O—[R⁹—O]ₜ—H (I-3)

wherein:
R⁶ is as defined above;
R⁹ represents a saturated or unsaturated, linear or branched, aliphatic or cyclic, divalent alkylene radical comprising from 2 to 4 carbon atoms and t is an integer ranging from 2 to 120, preferably from 1 to 10, t preferably being equal to 2 or 3.

Among the monomers of formula (I-1), mention may be made, for example, of 2-hydroxyethyl methacrylate (HEMA), 2-hydroxypropyl methacrylate, 4-hydroxybutyl methacrylate, 2-hydroxybutyl methacrylate, 2-hydroxyethyl acrylate (HEA), 2-hydroxypropyl acrylate (HPA), 4-hydroxybutyl acrylate (4-HBA) (for example available from Sartomer, Cognis or BASF).

Preferably, the monomer M2 is 2-hydroxyethyl methacrylate (HEMA):

CH₂═C(Me)-C(═O)—O—CH₂—CH₂—OH [Chem 14]

### Step E1)

The polyaddition reaction E1) can be carried out at a temperature preferably of less than 95° C. and/or under preferably anhydrous conditions.

The polyaddition reaction can be carried out in the presence or absence of at least one catalyst.

The reaction catalyst(s) which can be used during the polyaddition reaction can be any catalyst known to those skilled in the art for catalyzing the formation of polyurethane by reaction of at least one polyisocyanate with at least one polyol.

An amount ranging up to 0.3% by weight of catalyst(s), relative to the weight of the reaction medium of the polyaddition step, can be used.

The polyaddition reaction E1) can be carried out in the presence or absence of at least one solvent. The solvent can be chosen from solvents which do not react with the reactive functions of the ingredients used in step E1). It can, for example, be methyl methacrylate, toluene, ethyl acetate, xylene and mixtures thereof.

Step E1) is preferably carried out in amounts of reactants such that the NCO/OH molar ratio (r1) ranges from 1.5 to 5, preferably from 1.5 to 2.5.

In the context of the invention, and unless otherwise mentioned, (r1) is the NCO/OH molar ratio corresponding to the molar ratio of the number of isocyanate (NCO) groups to the number of hydroxyl (OH) groups carried by respectively all of the polyisocyanate(s) and all of the alcohol(s) present in the reaction medium of step E1) (polyol(s)).

The polyurethane obtained in step E1) preferably has two NCO end groups, in the end position of the main chain.

Step E2)

Step E2) can be carried out at a temperature preferably of less than 80° C., preferentially less than or equal to 60° C., and/or under preferably anhydrous conditions.

Step E2) can be carried out in the presence or absence of at least one catalyst. It can be the same catalyst as that used in step E1).

Step E2) can be carried out in the presence or absence of at least one solvent. The solvent can be chosen from solvents which do not react with the reactive functions of the ingredients used in step E2). It can, for example, be methyl methacrylate, toluene, ethyl acetate, xylene and mixtures thereof.

Preferably, step E2) is carried out by addition of the monomer(s) M2 to the reaction medium of step E1), without isolation of the product formed in step E1).

Step E2) is preferably carried out in amounts of reactants such that the OH/NCO molar ratio (r2) is less than or equal to 1, preferentially ranges from 0.90 to 1.0 and more preferentially still ranges from 0.95 to 1.00.

In the context of the invention, and unless otherwise mentioned, (r2) is the OH/NCO molar ratio corresponding to the molar ratio of the number of hydroxyl (OH) groups to the number of isocyanate (NCO) groups carried respectively by all of the alcohol(s) and of the isocyanate(s) (as regards in particular the polyurethane having NCO endings and optionally the polyisocyanate(s) which have not reacted on conclusion of step E1)) present in the reaction medium of step E2).

At the outcome of step E2, the polyurethane P can be in solution in a solvent such as, for example, methyl methacrylate. The polyurethane content in the solution can range from 40% to 80% by weight, preferably from 50% to 70% by weight.

The total content of polyurethane P in component A may be greater than or equal to 5% by weight, preferably greater than or equal to 8% by weight, and even more preferentially greater than or equal to 10% by weight, and advantageously greater than or equal to 13% by weight, relative to the total weight of component A.

(Meth)Acrylate Monomers M1

The monomer M1 is chosen from among the following compounds and mixtures thereof:

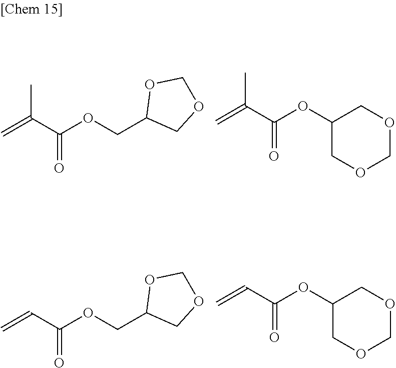

Preferably the (meth)acrylate monomer M1 is a methacrylate monomer.

Preferably, the component A comprises a mixture of the following compounds:

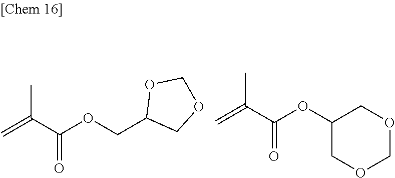

The total content of (meth)acrylate monomer(s) M1 in component A may be greater than or equal to 30% by weight, preferably greater than or equal to 40% by weight, and even more preferentially greater than or equal to 50% by weight, and in particular greater than or equal to 55% by weight, relative to the total weight of component A.

Reducing Agent

The reducing agent can be chosen from tertiary amines, sodium metabisulfite, sodium bisulfite, transition metals, azo compounds, alpha-aminosulfones, and mixtures thereof.

The reducing agent can be contained in the polyurethane P. This embodiment is for example possible when, in the above-mentioned step E1), the polyols and the polyisocyanates are reacted with a tertiary amines having pendent hydroxyl functions, such as for example Bisomer® PTE sold by Geo Speciality Chemicals or else la N-(2-hydroxyethyl)-N-methylaniline or else N-(2-hydroxyéthyl)-N-méthyl-p-toluidine.

Among the azo compounds, mention may for example be made of azoisobutyric acid.

Among the alpha-sulfones, mention may for example be made of bis(tolylsulfonylmethyl)benzylamine.

Among the tertiary amines, mention may for example be made of diisopropanol-p-toluidine (DIIPT); dimethyl-p-toluidine; dipropoxy-p-toluidine; dimethylaniline; N,N-dimethylaminomethylphenol; N,N-diisopropanol-p-chloroaniline; N,N-diisopropanol-p-bromoaniline; N,N-diisopropanol-p-bromo-m-methylaniline; N,N-dimethyl-p-chloroaniline; N,N-dimethyl-p-bromoaniline; N,N-diethyl-p-chloroaniline; N,N-diethyl-p-bromoaniline; and mixtures thereof.

Preferably, component A comprises at least one tertiary amine.

Component A may comprise a content of reducing agent ranging from 0.5% to 5%, preferably from 0.5% to 3%, by weight relative to the total weight of component A.

Component B

The oxidizing agent can be chosen from peroxides, organic salts of transition metals, compounds containing a labile chlorine, and mixtures thereof.

The peroxide can be chosen from organic peroxides, inorganic peroxides and mixtures thereof.

Mention may be made, among the inorganic peroxides, of peroxydisulfuric acid and its salts, such as ammonium peroxodisulfate, sodium peroxodisulfate and potassium peroxodisulfate.

Mention may be made, among the organic peroxides, of cumene hydroperoxide, para-menthane hydroperoxide, tert-butyl peroxyisobutyrate, tert-butyl peroxybenzoate, tert-butyl peroxyneodecanoate, tert-amyl peroxypivalate, acetyl peroxide, benzoyl peroxide, dibenzoyl peroxide, 1,3-bis(t-butylperoxyisopropyl)benzene, diacetyl peroxide, t-butylcumyl peroxide, tert-butyl peroxyacetate, cumyl peroxide, 2,5-dimethyl-2,5-di(t-butylperoxy)hexane, 2,5-dimethyl-2,5-di(t-butylperoxy)hex-3-yne, 4-methyl-2,2-di(t-butylperoxy)pentane and mixtures thereof.

Preferably, component B comprises benzoyl peroxide.

Component B may comprise a total content of reducing agent greater than or equal to 20%, preferably greater than or equal to 30%, by weight, advantageously greater than or equal to 50% by weight relative to the total weight of component B.

The composition according to the invention can typically comprise a redox system, a reducing agent which is included in part A and an oxidizing agent which is included in part B. Mention may for example be made of the following combinations:
persulfates (oxidizing agent)/(sodium metabisulfite and/or sodium bisulfite) (reducing agents);
organic peroxides (oxidizing agent)/tertiary amines (reducing agent);
organic hydroperoxides (oxidizing agent)/transition metals (reducing agent).

Composition

The composition may comprise at least one (meth)acrylate monomer in component A and/or in component B.

The (meth)acrylate monomers can comprise one (monofunctional) or more (polyfunctional) (meth)acrylate functions.

The (meth)acrylate monomer(s) can be chosen from the group consisting of:
compounds having the following formula (II):

[Chem 17]

CH₂═C(R¹⁰)—COOR¹¹ (II)

wherein:
R¹⁰ represents a hydrogen atom or an alkyl group comprising from 1 to 4 carbon atoms;
R¹¹ is chosen from the group consisting of alkyls, cycloalkyls, alkenyls, cycloalkenyls, alkylaryls, arylalkyls and aryls, it being possible for said alkyls, cycloalkyls, alkenyls, cycloalkenyls, alkylaryls, arylalkyls or aryls to be optionally substituted and/or interrupted by at least one silane, one silicone, one oxygen, one halogen, one carbonyl, one hydroxyl, one ester, one urea, one urethane, one carbonate, one amine, one amide, one sulfur, one sulfonate or one sulfone;
polyethylene glycol di(meth)acrylates;
tetrahydrofuran (meth)acrylates;
hydroxypropyl (meth)acrylate;
hexanediol di(meth)acrylate;
trimethylolpropane tri(meth)acrylate;
diethylene glycol di(meth)acrylate;
triethylene glycol di(meth)acrylate;
tetraethylene glycol di(meth)acrylate;
dipropylene glycol di(meth)acrylate;
di(pentamethylene glycol) di(meth)acrylate;
diglyceryl tetra(meth)acrylate;
tetramethylene di(meth)acrylate;
ethylene di(meth)acrylate;
bisphenol A mono- and di(meth)acrylates;
bisphenol F mono- and di(meth)acrylates; and
mixtures thereof.

According to one embodiment, the (meth)acrylate monomer is chosen from methyl (meth)acrylate, ethyl (meth)acrylate, 2-ethylhexyl (meth)acrylate, heptyl (meth)acrylate, 2-tert-butylheptyl (meth)acrylate, octyl (meth)acrylate, 3-isopropylheptyl (meth)acrylate, nonyl (meth)acrylate, decyl (meth)acrylate, undecyl (meth)acrylate, 5-methylundecyl (meth)acrylate, dodecyl (meth)acrylate, 2-methyldodecyl (meth)acrylate, tridecyl (meth)acrylate, 5-methyltridecyl (meth)acrylate, tetradecyl (meth)acrylate, pentadecyl (meth)acrylate, hexadecyl (meth)acrylate, 2-methylhexadecyl (meth)acrylate, heptadecyl (meth)acrylate, 5-isopropylheptadecyl (meth)acrylate, 4-tert-butyloctadecyl (meth)acrylate, 5-ethyloctadecyl (meth)acrylate, 3-isopropyloctadecyl (meth)acrylate, octadecyl (meth)acrylate, nonadecyl (meth)acrylate, eicosyl (meth)acrylate, 3-vinylcyclohexyl (meth)acrylate, bornyl (metha)crylate, 2,4,5-tri-t-butyl-3-vinylcyclohexyl (meth)acrylate, 2,3,4,5-tetra-t-butylcyclohexyl (meth)acrylate; benzyl (meth)acrylate, phenyl (meth)acrylate, 2-(2-ethoxyethoxy)ethyl (meth)acrylate, 2-phenoxyethyl (meth)acrylate, and mixtures thereof.

Preferably, the (meth)acrylate monomer is a methacrylate.

Preferably, the (meth)acrylate monomer is methyl methacrylate.

According to one preferred embodiment, the composition does not comprise (meth)acrylate monomer (except for the specific monomer M1 of component A).

The two-component composition according to the invention can comprise at least one additive chosen from the group consisting of catalysts, fillers, antioxidants, light stabilizers/UV absorbers, metal deactivators, antistatics, antifogging agents, foaming agents, biocides, plasticizers, lubricants, emulsifiers, dyes, pigments, rheological agents, impact modifiers, adhesion promoters, optical brighteners, flame retardants, antisweating agents, nucleating agents, solvents and mixtures thereof.

These additives can be present in component A and/or component B of the composition according to the invention.

As examples of plasticizers that may be used, mention may be made of any plasticizer normally used in the field of adhesives, for instance phthalates, benzoates, trimethylolpropane esters, trimethylolethane esters, trimethylolmethane esters, glycerol esters, pentaerythritol esters, naphthenic mineral oils, adipates, cyclohexyldicarboxylates, paraffinic oils, natural oils (optionally epoxidized), polypropylenes, polybutylenes, hydrogenated polyisoprenes, and mixtures thereof.

Preferably, use is made of:
diisodecyl phthalate, such as, for example, sold under the name Palatinol™ DIDP by BASF,
an ester of alkylsulfonic acid and of phenol, such as, for example, sold under the name Mesamoll® by Lanxess,
diisononyl 1,2-cyclohexanedicarboxylate, such as, for example, sold under the name Hexamoll Dinch® by BASF,
pentaerythritol tetravalerate, such as, for example, sold under the name Pevalen™ by Perstorp,
the epoxidized soya bean oil as for example sold under the name Vikoflex® 7170 by Arkema.

As examples of (thixotropic) rheological agent(s) that may be used, mention may be made of any rheological agent customarily used in the field of adhesive compositions.

Preferably, the thixotropic agents are chosen from:
PVC plastisols, corresponding to a suspension of PVC in a plasticizing agent which is miscible with PVC, obtained in situ by heating to temperatures ranging from 60° C. to 80° C. These plastisols can be those described in particular in the publication Polyurethane Sealants, Robert M. Evans, ISBN 087762-998-6,
fumed silica, such as, for example, sold under the name HDK® N20 by Wacker;
urea derivatives resulting from the reaction of an aromatic diisocyanate monomer, such as 4,4′-MDI, with an aliphatic amine, such as butylamine. The preparation of such urea derivatives is described in particular in the application FR 1 591 172;
micronized amide waxes, such as Crayvallac SLT sold by Arkema.

The composition according to the invention may also comprise at least one organic and/or mineral filler.

The mineral filler(s) that may be used is (are) advantageously chosen so as to improve the mechanical performance of the composition according to the invention in the crosslinked state.

As examples of mineral filler(s) that may be used, use may be made of any mineral filler(s) usually used in the field of adhesive compositions. These fillers are typically in the form of particles of diverse geometry. They may be, for example, spherical or fibrous or may have an irregular shape.

Preferably, the filler(s) is (are) chosen from the group consisting of clay, quartz, carbonate fillers, kaolin, gypsum, clays and mixtures thereof; preferentially, the filler(s) is (are) chosen from carbonate fillers, such as alkali metal or alkaline-earth metal carbonates, and more preferentially calcium carbonate or chalk.

These fillers may be untreated or treated, for example using an organic acid, such as stearic acid, or a mixture of organic acids predominantly consisting of stearic acid.

Use may also be made of hollow mineral microspheres, such as hollow glass microspheres, and more particularly those made of calcium sodium borosilicate or of aluminosilicate.

The composition according to the invention may also comprise at least one adhesion promoter, preferably chosen from silanes, such as aminosilanes, epoxysilanes or acryloyl silanes, or adhesion promoters based on a phosphate ester, such as for example the 2-hydroxyethyl methacrylate phosphate ester, 2-methacryloyloxyethyl phosphate, bis(2-methacryloyloxyethyl phosphate), 2-acryloyloxyethyl phosphate, bis(2-acryloyloxyethyl phosphate), methyl-(2-methacryloyloxyethyl phosphate), ethyl-(2-methacryloyloxyethyl phosphate), a mixture of 2-hydroxyethyl methacrylate mono- and diphosphate esters.

When a solvent, in particular a volatile solvent, is present in the composition, its content is preferably less than or equal to 5% by weight, more preferably less than or equal to 3% by weight, relative to the total weight of the composition.

Preferably, the content of solvent(s) in the composition is between 0% and 5% by weight.

When a pigment is present in the composition, its content is preferably less than or equal to 3% by weight, more preferably less than or equal to 2% by weight, relative to the total weight of the composition. When it is present, the pigment can, for example, represent from 0.1% to 3% by weight or from 0.4% to 2% by weight, of the total weight of the composition.

The pigments can be organic or inorganic pigments.

For example, the pigment is TiO₂, in particular Kronos®2059 sold by Kronos.

The composition can comprise an amount of from 0.1% to 3%, preferably from 1% to 3%, by weight of at least one UV stabilizer or antioxidant. These compounds are typically introduced in order to protect the composition from degradation resulting from a reaction with oxygen which is liable to be formed by the action of heat or light. These compounds may include primary antioxidants which trap free radicals. The primary antioxidants may be used alone or in combination with other secondary antioxidants or UV stabilizers.

Mention may be made, for example, of Irganox®1010, Irganox B561, Irganox 245, Irgafos® 168, Tinuvin®328 or Tinuvin™ 770, which are sold by BASF.

According to one embodiment, the volume ratio of component A/component B in the composition of the invention ranges from 100/5 to 1/1, preferably from 20/1 to 1/1, preferably from 10/1 to 1/1.

According to a preferred embodiment, the abovementioned composition comprises:
a component A comprising:
   a total content of polyurethane(s) P as described above greater than or equal to 5% by weight;
   from 0.1% to 5% by weight of reducing agent(s);
   a total content of (meth)acrylate monomer M1 greater than or equal to 30% by weight;
   relative to the total weight of component A;
a component B comprising:
   a total content of oxidizing agent(s) greater than or equal to 20% by weight; and
   from 0% to 30% by weight of methacrylate monomer(s);

relative to the total weight of component B.

Preferably, the composition according to the invention is an adhesive composition.

Ready-for-Use Kit

The present invention also relates to a ready-for-use kit comprising component A as defined above, on the one hand, and component B as defined above, on the other hand, packaged in two separate compartments. It can, for example, be a two-component cartridge.

This is because the composition according to the invention can be in a two-component form, for example within a ready-for-use kit, comprising component A, on the one hand, in a first compartment or drum and component B, on the other hand, in a second compartment or drum, in proportions suitable for direct mixing of the two components, for example by means of a metering pump.

According to one embodiment of the invention, the kit additionally comprises one or more means making possible the mixing of the components A and B. Preferably, the mixing means are chosen from metering pumps or static mixers with a diameter suited to the amounts used.

Uses of the Compositions

The present invention also relates to the use of a composition as defined above as adhesive, mastic or coating, preferably as adhesive.

The invention also relates to the use of said composition in the repair and/or the structural or semistructural adhesive bonding of materials in the transportation, motor vehicle (car, bus or truck), assembly, marine or construction field.

The present invention also relates to a method for assembling two substrates by adhesive bonding, comprising:
the coating, onto at least one of the two substrates to be assembled, of a composition obtained by mixing the components A and B as defined above; then
the effective bringing of the two substrates into contact;
the crosslinking of the composition.

The crosslinking step can be carried out at a temperature between 0° C. and 200° C., preferably between 10° C. and 150° C., preferably between 23° C. and 80° C. and in particular between 20° C. and 25° C.

The crosslinking can also be induced using microwaves.

The appropriate substrates are, for example, inorganic substrates, such as concrete, metals or alloys (such as aluminum alloys, steel, non-ferrous metals and galvanized metals); or else organic substrates, such as wood, plastics, such as PVC, polycarbonate, PMMA, polyethylene, polypropylene, polyesters, epoxy resins; substrates made of metal and composites coated with paint.

The compositions according to the invention once lead advantageously, after crosslinking, to an adhesive seal exhibiting semi-structural or structural properties.

The composition according to the invention advantageously results in an adhesive seal having a modulus at break greater than or equal to 20 MPa, and in particular greater than or equal to 25 MPa.

The compositions according to the invention advantageously exhibit, after crosslinking, good adhesive properties, while having little or no odor.

All the embodiments described above can be combined with one another. In particular, the different abovementioned constituents of the composition, and especially the preferred embodiments of the composition, can be combined with one another.

In the context of the invention, the term “of between x and y” or “ranging from x to y” is understood to mean an interval in which the limits x and y are included. For example, the range “between 0% and 25%” includes in particular the values 0% and 25%.

The invention is now described in the following exemplary embodiments, which are given purely by way of illustration and should not be interpreted in order to limit the scope thereof.

### EXAMPLES

The following ingredients were used:
2-hydroxyethyl methacrylate (HEMA) sold by Aldrich (OHN=430 mg KOH/g);
Voranol™ P2000 sold by Dow is a polypropylene glycol (PPG) of functionality equal to 2 having an OHN of 56 mg KOH/g;
Borchi Kat®315: catalyst based on bismuth neodecanoate (available from Borchers);
Desmodur 44 MC Flakes sold by Covestro is a pure 4,4′-MDI.
Bisomere PTE (CAS Number: 103671-44-9) sold by GEO Specialty Chemicals;
SR9054 (CAS Number: 1628778-81-3) sold by Sartomer: difunctional acrylic acid adhesion promoter;
Aerosil® R202 (CAS Number: 67762-90-7): a hydrophobic fumed silica (post-treated PDMS) with a specific surface area (BET) equal to 100±20 m²/g sold by Evonik;
MBS Clearstrength® XT100 sold by Arkema: a core-shell base MBS MMA-butadiene-styrene impact modifier;
Retic™ BP50 sold by Luperox is benzoyl peroxide (48-52% weight/weight) in an Isononyl benzoate (12-15%)/Ethylene Glycol (8-10%) mixture;
Vikoflex 7170 sold by Arkema is an epoxidized soybean oil used as a plasticizer;
Crayvallac SLT sold by Arkema is a micronized amide wax used as a rheological agent;
Visiomer® Glyfoma (CAS: 1620329-57-9): Weight-average molecular weight (Mw) being equal to 172.2 g/mol, mixture of glycerol formal methacrylate isomers;
Bisomer IPGMA: isopropylidene glycerol methacrylate (CAS:7098-80-8) sold by the company Geo Chemical.

### Example 1: Preparation of the Polyurethane P1

TABLE 1

| | Quantity | Quantity |
|---|---|---|
| Ingredients | (g) | (%) |
| Voranol P2000 | 199.59 | 66.53 |
| Desmodur 44 MC | 61.89 | 20.63 |
| Borchi KAT315 | 0.03 | 0.010 |
| 2-hydroxyethyl | 38.49 | 12.83 |
| methacrylate (HEMA) | | |

The Voranol™ P2000 polyol was introduced into a reactor and heated at 90° C. under vacuum for approximately 1 h in order to dehydrate the polyol. Desmodur 44 MC was introduced into the reactor and heated at 70° C. for approximately 2 h. After a few minutes, the catalyst and the 2-hydroxyethyl methacrylate were introduced, and the reaction medium was mixed at 60° C. for 1 h.

### Example 2: Preparation of the Compositions

The various ingredients constituting the component A are mixed in the proportions shown in the following table, at a temperature of 23° C., in a reactor kept constantly stirred and under nitrogen.

The various ingredients constituting the component B are mixed in the proportions shown in the following table, at a temperature of 23° C., in a reactor kept constantly stirred and under nitrogen.

TABLE 2
Composition No. 1

| | |
|---|---|
| Component A | Component B |

| | % by weight | | % by weight |
|---|---|---|---|
| | (relative to the | | (relative to the |
| ingredients | total weight of A) | ingredients | total weight of B) |
| Polyurethane P1 | 14.9 | Retic BP 50 | 71 |
| Visiomer Glyfoma | 60.6 | Vikoflex 7170 | 25 |
| XT 100 | 17.2 | Crayvallac SLT | 4 |
| Methacrylic acid | 1.3 | | |
| SR 9054 | 0.9 | | |
| Aerosil R202 | 5.1 | | |
| Total | 100 | Total | 100 |

The component A and the component B above were mixed, in a 10:1 volume ratio.

The mixing is carried out at a temperature of approximately 23° C., according to the given ratio by volume, with a static mixer.

A comparative composition No. 2 was prepared in the same way with the following ingredients:

TABLE 3
Composition No. 2 (comparative)

| | |
|---|---|
| Component A | Component B |

| ingredients | % | ingredients | % |
|---|---|---|---|
| Polyurethane P1 | 15 | Retic BP 50 | 71 |
| Bisomer IPGMA | 60 | Vikoflex 7170 | 25 |
| XT 100 | 18 | Crayvallac SLT | 4 |
| Methacrylic acid | 1.5 | | |
| SR 9054 | 0.8 | | |
| Aerosil R202 | 3.7 | | |
| Bisomer PTE | 1 | | |
| Total | 100 | Total | 100 |

### Example 3: Results

Measurement of the Breaking Strength by Tensile Testing:

The measurement of the strength (tensile strength) by tensile testing was performed according to the protocol described below.

The principle of the measurement consists in drawing, in a tensile testing device, the movable jaw of which moves at a constant rate equal to 100 mm/minute, a standard test specimen consisting of the crosslinked composition and in recording, at the moment when the test specimen breaks, the tensile stress applied (in MPa) and also the elongation of the test specimen (in %). The standard test specimen is dumbbell-shaped, as illustrated in the international standard ISO 37 of 2011. The narrow part of the dumbbell used has a length of 20 mm, a width of 4 mm and a thickness of 500 μm.

Adhesive Bonding Tests

The adhesive bondings are produced on strips made of aluminum originating from Rocholl. A zone of 25*12.5 mm was delimited on a strip using wedges made of Teflon with a thickness of 250 μm a zone of 25*12.5 mm. This area was filled with the test composition and then a second strip of the same material was laminated. The combination was held by a clamp and placed in a climate-controlled chamber at 23° C. or at 100° C. and 50% RH (relative humidity) for a week before tensile testing on a universal testing machine. The aim of the tensile testing on a universal testing machine is to evaluate the maximum force (in MPa) to be exerted on the assemblage in order to separate it. Recourse to a tensile testing device makes it possible to subject a simple lap joint placed between two rigid supports to a shear stress up to failure by exerting tension on the supports parallel to the surface of the assemblage and to the main axis of the test specimen. The result to be recorded is the breaking force or stress. The shear stress is applied via the movable jaw of the tensile testing device with a displacement at the rate of 5 mm/min. This tensile testing method is carried out as defined by the standard EN 1465 of 2009.

The properties obtained for the compositions prepared are summarized in the table below:

TABLE 4

| | | | Test specimen H2 |
|---|---|---|---|
| | Adhesive bonding at 23° C. | | Tensile strength |
| Composition | F max (MPa) | Facies | (MPa) |
| Composition No. 1 | 21.3 | CF | 25 |
| Composition No. 2 | 12 | Semi-cohesive failure | 10 |
| (comparative) | | | |

CF: cohesive failure
AR: adhesive rupture
F max: maximum force at the time of the failure of the adhesive bonding

Composition No. 1 advantageously results in adhesive bonding on aluminum leading to a cohesive failure (CF), which denotes in particular good adhesion in the automotive field compared to obtaining an adhesive rupture AR. In addition, the maximum force (Fmax) at the moment of rupture is advantageously higher with composition No. 1 than that obtained with comparative composition No. 2.

In addition, composition No. 1 advantageously results in an adhesive seal having, after crosslinking, a tensile strength greater than that obtained with composition No. 2 (comparative).

1-18. (canceled)

19. A two-component composition comprising:
a component A comprising:
at least one polyurethane P comprising at least two (meth)acrylate end functions;
at least one reducing agent; and
at least one (meth)acrylate monomer M1 selected from the group consisting of the following compounds and mixtures thereof: 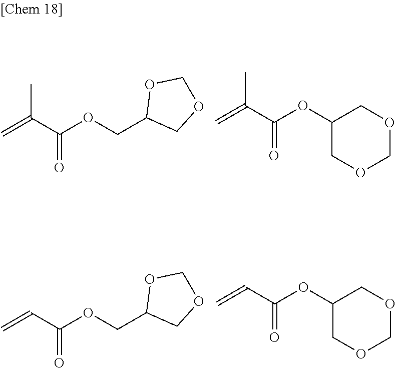
a component B comprising:
at least one oxidizing agent; and
optionally at least one (meth)acrylate monomer.

20. The composition as claimed in claim 19, wherein the polyurethane P has a number-average molecular weight (Mn) greater than or equal to 2000 g/mol.

21. The composition as claimed in claim 19, wherein the polyurethane P is obtained by a method comprising:
E1) a step of preparing a polyurethane comprising at least two NCO end groups comprising the polyaddition reaction between:
i. at least one polyisocyanate; and
ii. at least one polyol;
E2) reacting the product formed at the outcome of step E1) with at least one (meth)acrylate monomer M2 comprising at least one hydroxyl function.

22. The composition as claimed in claim 21, wherein the at least one polyisocyanate is a diisocyanate, selected from the group consisting of isophorone diisocyanate (IPDI), hexamethylene diisocyanate (HDI), heptane diisocyanate, octane diisocyanate, nonane diisocyanate, decane diisocyanate, undecane diisocyanate, dodecane diisocyanate, 2,4′-methylenebis(cyclohexyl isocyanate) (2,4′-H6MDI), 4,4′-methylenebis(cyclohexyl isocyanate) (4,4′-H6MDI), norbornane diisocyanate, norbornene diisocyanate, 1,4-cyclohexane diisocyanate (CHDI), methylcyclohexane diisocyanate, ethylcyclohexane diisocyanate, propylcyclohexane diisocyanate, methyldiethylcyclohexane diisocyanate, cyclohexanedimethylene diisocyanate, 1,5-diisocyanato-2-methylpentane (MPDI), 1,6-diisocyanato-2,4,4-trimethylhexane, 1,6-diisocyanato-2,2,4-trimethylhexane (TMDI), 4-isocyanatomethyl-1,8-octane diisocyanate (TIN), 2,5-bis(isocyanatomethyl)bicyclo[2.2.1]heptane (2,5-NBDI), 2,6-bis(isocyanatomethyl)bicyclo[2.2.1]heptane (2,6-NBDI), bis(isocyanatomethyl)cyclohexane (H6-XDI), xylylene diisocyanate (XDI), toluene diisocyanate, diphenylmethane diisocyanate, tetramethylxylylene diisocyanate (TMXDI), an HDI allophanate having, for example, the following formula (Y): 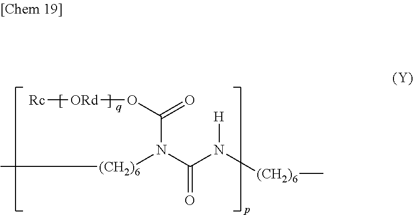
wherein p is an integer ranging from 1 to 2, q is an integer ranging from 0 to 9, R_{c} represents a saturated or unsaturated, cyclic or acyclic, linear or branched, hydrocarbon-based chain comprising from 1 to 20 carbon atoms, and R_{d} represents a linear or branched divalent alkylene group having from 2 to 4 carbon atoms;
and mixtures thereof.

23. The composition as claimed in claim 21, wherein the polyol(s) is (are) chosen from polyester polyols, polyether polyols, polyene polyols, polycarbonate polyols, poly(ether-carbonate) polyols and mixtures thereof.

24. The composition as claimed in claim 21, wherein the (meth)acrylate monomer M2 is chosen from those having the following formula (I):
[Chem 20]
CH₂═C(R⁶)—C(═O)—O—R⁷—OH (I)
wherein:
R⁶ represents a methyl or a hydrogen;
R⁷ represents a saturated or unsaturated, aliphatic or cyclic, linear or branched, divalent hydrocarbon radical comprising from 2 to 240 carbon atoms, and being optionally interrupted by one or more heteroatoms, and/or optionally interrupted by one or more aromatic groups, and/or optionally comprising one or more divalent —N(Rₐ)— groups with Rₐ representing a linear or branched alkyl radical comprising from 1 to 22 carbon atoms (tertiary amine), —C(═O)O— (ester), —C(═O)NH— (amide), —NHC(═O)O— (carbamate), —NHC(═O)—NH— (urea) or —C(═O)— (carbonyl) groups, and/or being optionally substituted.

25. The composition as claimed in claim 21, wherein the monomer M2 is chosen from the group consisting of 2-hydroxyethyl methacrylate, 2-hydroxypropyl methacrylate, 4-hydroxybutyl methacrylate, 2-hydroxybutyl methacrylate, 2-hydroxyethyl acrylate, 2-hydroxypropyl acrylate, and 4-hydroxybutyl acrylate.

26. The composition as claimed in claim 19, wherein the total content of polyurethane P in component A is greater than or equal to 5% by weight, relative to the total weight of component A.

27. The composition as claimed in claim 19, wherein the (meth)acrylate monomer M1 is a methacrylate monomer.

28. The composition as claimed in claim 19, wherein the component A comprises a mixture of the following compounds:

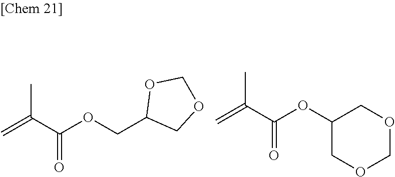

29. The composition as claimed in claim 19, wherein the total content of (meth)acrylate monomer(s) M1 in component A is greater than or equal to 30% by weight, relative to the total weight of component A.

30. The composition as claimed in claim 19, wherein the reducing agent is selected from the group consisting of tertiary amines, sodium metabisulfite, sodium bisulfite, transition metals, azo compounds, alpha-aminosulfones, and mixtures thereof.

31. The composition as claimed in claim 19, wherein the oxidizing agent is selected from the group consisting of peroxides, organic salts of transition metals, compounds containing a labile chlorine, and mixtures thereof.

32. The composition as claimed in claim 19, wherein it comprises, in component A and/or component B, at least one additive selected from the group consisting of catalysts, fillers, antioxidants, light stabilizers/UV absorbers, metal deactivators, antistatics, antifogging agents, foaming agents, biocides, plasticizers, lubricants, emulsifiers, dyes, pigments, rheological agents, impact modifiers, adhesion promoters, optical brighteners, flame retardants, anti-sweating agents, nucleating agents, solvents, and mixtures thereof.

33. The composition as claimed in claim 19, wherein the volume ratio of component A/component B in the composition of the invention ranges from 100/5 to 1/1.

34. A ready-for-use kit comprising, on the one hand, component A as defined in claim 19 and, on the other hand, component B as defined in claim 19, packaged in two separate compartments.

35. An adhesive comprising the composition as defined in claim 19.

36. The adhesive of claim 35, configured for use in the repair and/or the structural or semistructural adhesive bonding of materials in the transportation, automobile, marine, assembly or construction fields.
